(19) United States
(12) Patent Application Publication
(10) Pub. No.: US 2012/0232921 A1
(43) Pub. Date: Sep. 13, 2012

(54) SYSTEM AND METHOD FOR ENSURING INTEGRITY OF CLINICAL TRIAL RESULTS

(75) Inventors: Guillermo J. DICLEMENTE, Yardley, PA (US); William Christian YAVORSKY, Brooklyn, NY (US)

(73) Assignee: CRONOS CCS, Hamilton, NJ (US)

(21) Appl. No.: 13/414,271

(22) Filed: Mar. 7, 2012

Related U.S. Application Data
(60) Provisional application No. 61/449,976, filed on Mar. 7, 2011.

(51) Int. Cl. G06Q 50/22

(52) U.S. Cl. 705/2

(57) ABSTRACT

The system and method utilize the inter-relationship of items in a psychological instrument or instruments and have been demonstrated empirically to detect problematic conceptualizations of constructs. Scores from the instruments are submitted for review. The scores are analyzed by a computer program that compares item level scores with expected values based on the item inter-relationships. If inconsistencies are discovered a flag is generated. If inconsistencies are deemed actionable then remedial action or contact is scheduled with the site-based clinician or “rater” who conducted the patient assessment using the instrument or instruments. The site-based clinician is contacted and an information exchange about the case occurs in which the site-based clinician provides an overview of symptom presentation. This symptom presentation is then matched to the item level scores on the instrument to determine if it was scored in a manner consistent with the conceptual basis for the items.

This application claims the benefit of provisional application 61/449,976, filed Mar. 7, 2011, the entire content of which are incorporated herein by reference.

### BACKGROUND OF THE INVENTION

Development of new medications is an expensive, time-consuming process. The process begins with an understanding of the causes of the condition to be treated and of physiology. The developer works from a theory on how the medication will prevent or treat a condition based on the most advanced knowledge of the condition. Once a medication is developed, however, there is still a need to demonstrate the efficacy of the medication. In other words, it is necessary to prove that what works in theory actually works in reality.

Psychiatric medications use psychometric tests (“instruments”). These instruments include but are not limited to:
PANSS (Positive and Negative Syndrome Scale)
HAM-D/SIGHD (Hamilton depression rating scale/Structured Interview Guide for the Hamilton depression rating scale)
YMRS (Young Mania Rating Scale)
BPRS (Brief Psychiatric Rating Scale)
MADRS (Montgomery-Asberg Depression Rating Scale)

These instruments are used in psychiatric clinical trials by trained clinicians to measure change in patient symptoms in response to the administration of a study compound (a psychiatric medication) or placebo. The instruments produce numerical scores on a range of items (an “item” is an individual dimension of a psychiatric construct, e.g., loss of appetite in depression or delusions in schizophrenia) that are then summed to produce a total score. The instruments are given at set intervals defined by the study protocol and the resulting scores recorded.

Any diagnosis depends on the observation of symptoms associated with the condition. The symptoms are given a quantitative score after observation and interviews with the subject. For any condition, some symptoms are related so that a correlation between the value accorded to one symptom and the value of another symptom can be expected. Any deviation from the expected correlation can be indicative of improper quantification.

It is an object of the invention to provide a system and method for detecting improper values assigned to symptoms of a condition.

It is another object of the invention to provide a system for detecting deviations from expected correlations between values given to different symptoms of a condition.

These and other objects of the invention will be apparent from reading the following disclosure of the invention.

### SUMMARY OF THE INVENTION

The system and method of the invention depend on the inter-relationship of the items in the instrument or instruments and have been demonstrated empirically to detect problematic conceptualizations of constructs. The data-monitoring process begins when the scores from the instruments are submitted for review. The scores are then analyzed by a computer program that compares item level scores with expected values based on the item inter-relationships. If inconsistencies are discovered a flag is generated. These flags are reviewed by a clinician with expertise in the individual instrument (this expertise is maintained through regular training sessions and ongoing contact with the instrument authors). If potential inconsistencies are deemed actionable then the clinician reports the case and a remedial action or contact (a “contact” includes but is not limited to an email, phone call, fax or video-conference) is scheduled with the site-based clinician or “rater” who conducted the patient assessment using the instrument or instruments. The site-based clinician is then contacted and an information exchange about the case occurs in which the site-based clinician provides an overview of symptom presentation. This symptom presentation is then matched to the item level scores on the instrument to determine if it was scored in a manner consistent with the conceptual basis for the items. The essential feature is to input the results of clinical trial data into the algorithm matrix and from the output effect an outcome.

### BRIEF DESCRIPTION OF THE DRAWINGS

FIG. 1 is a bar graph depicting values of factors associated with MADRS;

FIG. 2 is a bar graph depicting values of factors of different scales;

FIG. 3 is a bar graph depicting values of factors associated with depression;

FIG. 4 is a first bar graph depicting values of factors associated with HAMD; and

FIG. 5 is a second bar graph depicting values of factors associated with HAMD.

### DETAILED DESCRIPTION OF THE INVENTION

When the effectiveness of a drug is tested in clinical trials, the patient's response to the drug is monitored over a period of time. The symptoms of the condition being treated by the drug are monitored over a period of time and the patient's change in the symptoms is recorded. When the drug treats a condition such as blood pressure, the results are easy to quantify although there needs to be procedural safeguards to eliminate outside influences from affecting the results. However, when the conditions being treated are psychological conditions, the symptoms are harder to quantify and the possibility of the test takers or test givers subjective viewpoint can alter the results. The system and method of the invention provides a means to identify and correct results which are the result of test giver error.

The method detects abnormalities in administering a psychological instrument. The method includes administering questions to a patient to ascertain numerical values for at least two items for the psychological instrument, entering the numerical values for at least two items into a computer database, determining an expected correlation between the at least two items, comparing the values of the at least two items to expected values based on the correlation, and generating an alert in any appropriate manner, such as a text message or audio signal, when the difference between the actual values of the at least two items are different than the expected difference based on the correlation.

The system and method of the invention begins with the development of an algorithm for execution by a CPU of a computer. The first step is the identification and utilization of binary and factorial relationships between items within an instrument and, in some cases, between instruments. Factor analytic relationships determine the strength of relationships between multiple items. Factor analysis is a method that is used to determine variability between and among variables in an instrument such that those variables can be grouped to form a lower number of latent variables called factors. The thirty items of the PANS S, for example, are grouped into five latent variables called factors that contain the items that are most related. In the data-monitoring process the strength of the relationship between these factor items forms the basis for this component of the algorithms. Statistical analysis of test results reveals the binary and factorial relationship between items, both within an instrument and between instruments. The statistical analysis can be performed by a a computer using an appropriate program.

Binary relationships are those with 1:1 relationship wherein either a high score on one indicates a high score on another or the converse with a low score on one indicating a high score on another. The relationships can be developed theoretically, based on the factors the items measure and then confirmed with empirical evidence, or the relationships can be derived from empirical evidence. For instance, if a large pool of results reveal that in an overwhelming majority of cases, two items always have the same numerical value, or always have values which are within one point of each other, this relationship is considered to be a correspondence that the algorithm will investigate for future results. Test results that do not meet the expected correspondence are flagged for further investigation.

Binary relationships existing between items are tested using large data sets (n>500) to determine if the binaries can detect problematic score selection by test givers (raters). Binary relationships determined not to be substantially predictive of problematic score selection by raters are not utilized within the algorithm. For example, a binary relationship in the MADRS instrument might be a very high score on reported sadness and a very low score on pessimistic thoughts or inability to feel. This scenario is unlikely and would cause the algorithm to generate a flag. A binary example from the PANSS instrument is the item P5 (grandiosity) and the item P1 (delusions). If P5 is rated at the level of 6, then it is not possible for P1 to be any less than 5. The reason for this is that at the severity level of 6 the guidance for the severity level, otherwise known as the anchor, reads: Clear-cut delusions of remarkable superiority involving more than one parameter (wealth, knowledge, frame, etc.) are expressed, notable influence interactions, and may be acted upon. If the rater correctly applies the anchor and these elements are taken into consideration, clinically this is understood as not only significant grandiosity but also as a significant delusion. Therefore, the correlation between a severity level of 6 for grandiosity correlates with a level of at least 5 for delusions. The algorithm relies on such correlations and, in analyzing the data, produces a flag if the expected correlation does not exist. The expected correlation may be theoretically derived from the relationship between the two items (i.e. one expects grandiosity and delusions to be related and have similar scores), or derived from reviewing previous test scores for grandiosity and delusions and noting that the scores reveal a correspondence between the numerical values of these two items and one would expect future results to exhibit the same relationship.

Many instruments have the items separated into factors. The factors represent different aspects of a condition, such as physical and emotional symptoms of depression. Often, drugs are targeted toward one factor of a condition. When testing the drugs effectiveness, only items under that facto are tested. It is possible for a single item to be classified in more than one factor.

Factorial based algorithms rely on extant literature regarding a given instrument as well as the factor solutions derived using large data sets. Factor analysis reduces a set of variables to a smaller set sharing the same or similar features. For example, the PANSS instruments use a 5 factor solution for the thirty items.

In the following table, the factor loadings for the PANSS instrument are indicated:

| | | | Dysphoric | Autistic |
|---|---|---|---|---|
| Negative | Positive | Activation | Mood | preoccupation |
| N6 | P1 | P7 | G2 | G11 |
| N1 | G9 | G14 | G4 | G15 |
| N2 | P5 | P4 | G3 | N5 |
| N3 | P3 | G8 | G6 | N7 |
| N4 | G1 | N3 | G1 | G13 |
| G7 | | G4 | | P3 |
| G5 | | | | |
| G8 | | | | |
| G13 | | | | |
| G14 | | | | |

The five factors for the instrument are positive, negative, activation, dysphoric mood and autistic preoccupation. These factors contain the items of the scale which are designated by alphanumeric code (e.g., P1=delusions; P2=conceptual disorganization; P3=hallucinations; etc.) and, in the case of the PANSS, represent three subscales, the positive, negative and general. The items include N1-N7; G1-G16 and P1-P7. As can be seen, some items can be included in more than one factor, as G13 (disturbance of volition) appears under both Negative and Autistic preoccupation factors. The factor loadings allow the creation of algorithms that operate on the strength of the expected relationships given a population with this disorder (schizophrenia in this case). For example, if the relationship between the items that measure hostility (P7), uncooperativeness (G8) and poor impulse control (G14) are not consistent with the expected factor relationships, then this triggers the algorithm to generate a flag to be reviewed. These items all fall within the Activation factor and would be expected to have similar scores. A divergence in the score attributed to these factors would represent a problem of the test giver and would be recognized by the algorithm. A sample set of data might include the score of 2 on P7, 5 on G8 and 2 on G14. This information suggests that the items are not correlated in the way expected through the factor model, as the score for G8 does not have the expected relationship to the other items. Under such circumstances, the system alerts the user to the discrepancy that is then investigated. For other instruments the same procedure is followed. For example, the commonly accepted factor model for the MADRS involves three factors including: dysphoria/retardation; psychic anxiety; and vegetative symptoms. These factors, with the symptoms to be measured for each factor, are listed below.

| dysphoria/retardation | psychic anxiety | vegetative symptoms. |
|---|---|---|
| apparent sadness | inner tension | reduced sleep |
| reported sadness | pessimistic thoughts | reduced appetite |
| lassitude | suicidal thoughts | |
| reduced | | |
| concentration | | |
| inability to feel | | |

Relationships between these items are critical in the algorithms matrix structure that works alongside binary relationships between items. Binary relationships between individual items are also considered and an example might be the clinically relevant relationship between a higher score (i.e., 3 or higher) on the suicide item in the absence of a clinically significant score on depressed mood or pessimistic thoughts.

Once the initial factor relationships are established the testing phase begins. In this phase algorithms are uploaded to a SQL (Structured Query Language) server (or similar) that in the form of a pattern matrix with both the binary and factorial relationships outlined in code. Data from the specific instrument can then be entered and the algorithm is executed to screen the data against the expected relationships. If inconsistencies are detected in the expected relationship then the output of the program is a series of flags of varying severity level—flags may be serious as in the case of logical impossibilities and range to mild wherein the clinical presentation is unusual though possible. The flags are differentiated by the discrepancy between the measured difference between items as opposed to the expected differentiation.

The following are examples of the algorithms as applied to different instruments and the steps taken after a potential problem was found:
In the following examples some of the algorithms for the MADRS (Montgomery Asberg Depression Rating Scale and HAM-D (Hamilton Depression Rating Scale) will be discussed. These are scales that measure the severity of depression symptoms. In the same way as outlined above these algorithms operate within and between instruments. In the following two examples the presentation, action and outcomes of two clinical examples will be considered.

The first example involves an inconsistency detected within the MADRS. The algorithms were triggered for the potentially discrepant ratings between reported sadness (M1) and pessimistic thoughts (M9) (a binary relationship but also one suggested by the factor strcuture), but during the clinical discussion other issues emerged. These values are graphically depicted in FIG. 1.

In this example the rater is contacted and asked to give an overall clinical presentation of the patient for this visit. The rater describes a very anxious patient who reported panic attacks and feelings or irritability alongside feelings of despondency and hopelessness that dominated the patient's thinking. The rater was asked questions related first to the assessment of anxiety and determined that, in this case, the patient would have met criteria for a higher severity rating on the inner tension item based on the severity and impact of the symptoms—the rater having indicated that her score was based on only on the frequency of the symptoms. Next a discussion was had related to the severity rating on reported sadness and that although the hopelessness and guilt was expressed related to the assessment of a different item this should be considered in relation to depressed mood. The rater had scored reported sadness based on the report by the patient that there was some mood elevation when there was news related to the health of a relative but that the primary affective state was down over the past week. The rater was reminded not to change any of the scores but to apply the general feedback of scoring based on frequency, severity and impact as well as the consideration of all information obtained across the interview period. The outcome here is that the rater agreed to change her rating behavior going forward and not to change scores retrospectively. Should the rater have not agreed to this or if there was evidence in further cases that the rater was not in compliance, then the sponsor would be contacted to make a recommendation which could include discontinuation of recruitment to that site or simply a more detailed training session.

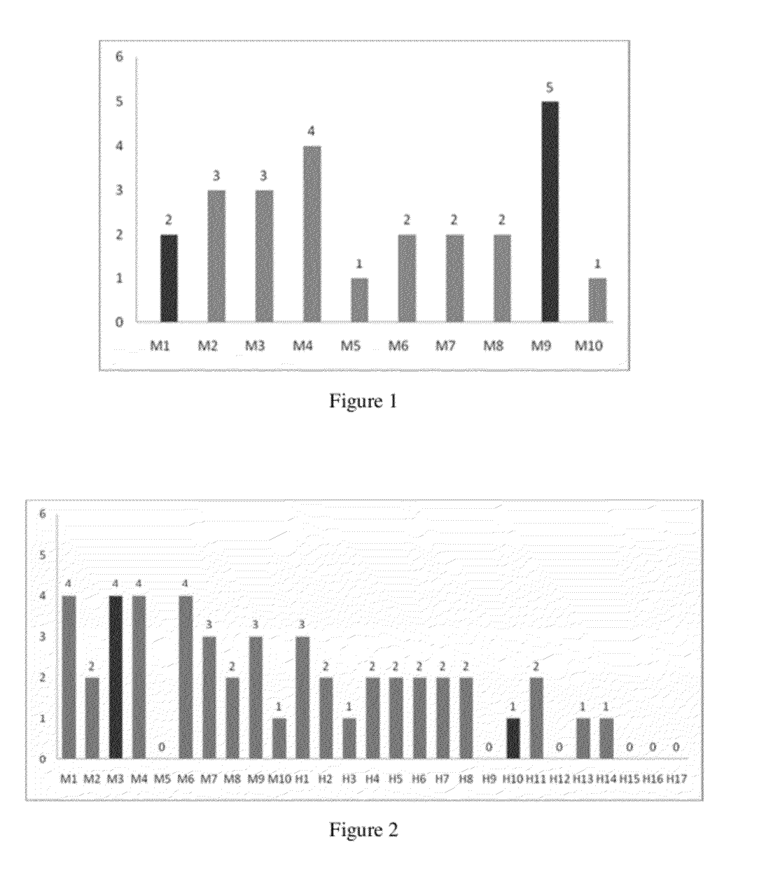

In the next example there was a potential discrepancy indicated between related constructs between scales, in this case the HAM-D and MADRS scales. Although the rater had a good understanding of each instrument there was a problem in the method by which information was gathered. These values are graphically depicted in FIG. 2.

The rater reported in this case that this was a patient with moderate symptoms of depression and that there had been little change from the previous week. The rater indicated that the patient had persistent anxiety that was present daily and that was somewhat difficult for the patient to control. When asked about how this was assessed in the anxiety psychic (H10) item on the HAM-D the rater reported that the patient had not endorsed that symptom during the administration of the Hamilton and that sequentially during the study the Hamilton was first and he felt that the patient felt more comfortable discussing these symptoms during the administration of the MADRS. The feedback was to integrate information obtained across scales in assigning severity ratings and to remember to clarify contradictory or ambiguous information.

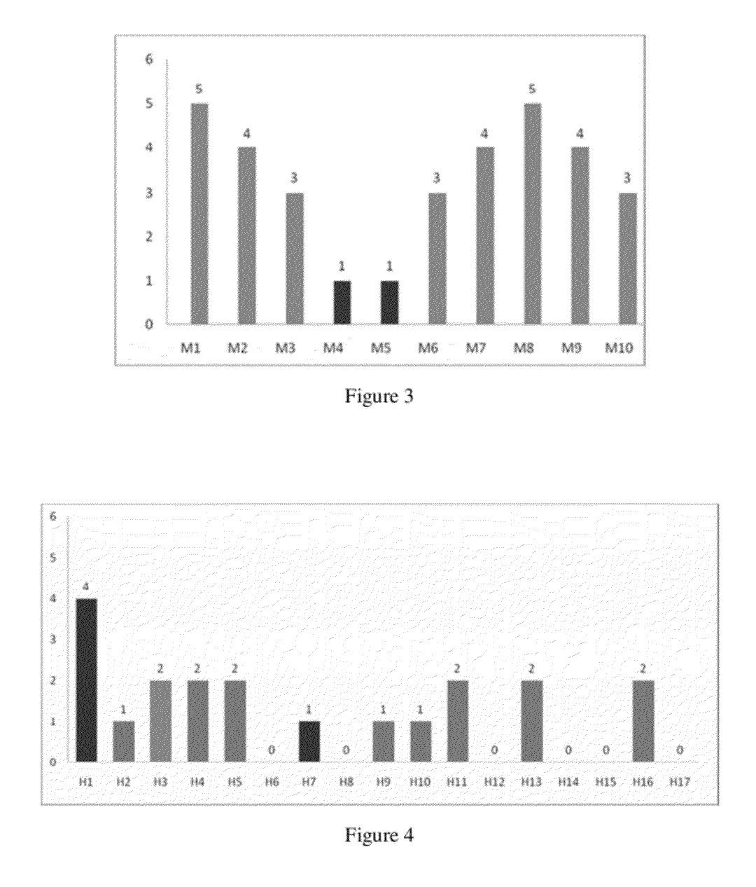

In terms of severity of the algorithm violations the following example is more subtle. Here the overall clinical picture is considered and moderate to moderately severe symptoms of depression but with little impact on sleep (M4) or appetite (M5) are observed, as seen in the bar graph of FIG. 3. While this is certainly a possible scenario the rater would be contacted to have a discussion about how the items were rated to confirm that the rater is conceptualizing these correctly.

In the following next two examples severity levels of some of the algorithms are shown: a case of a mild level of severity within the HAMD and another case where the severity level is high and is often an indication of an impossible relationship within the instrument and a case where almost certainly there is an issue with the rater's conceptualization of items.

The HAM-D scores depicted in FIG. 4 indicate a mild level of severity where clinically more impact on work and activities would be expected if depressed mood was scored at this level. This is an example of a possible relationship though one that merits clinical contact to ensure that there is a good rationale for the scores.

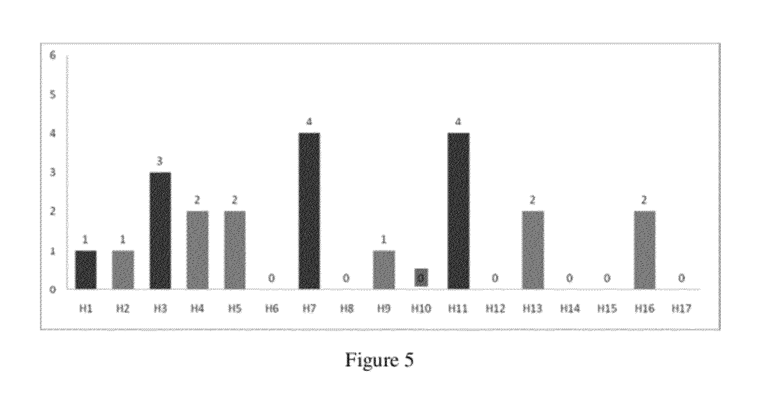

This set of HAM-D scores depicted in FIG. 5 indicates a high level of severity and it is unlikely that there is any adequate accounting for the algorithm violations. The clinical picture is someone with a high level of reported somatic anxiety symptoms in the absence of any reported psychic anxiety indicating that either the rater is capturing obvious medication side-effects or a physical condition which are not meant to be scored on this instrument or is not asking adequate follow up questions for the item. Also very unlikely in this presentation is the low severity score on depressed mood when the suicide and work and activities items are considered.

The examples above provide evidence that a person of ordinary skill in psychometric measures and analytics with a clinical background with the respective patient population could produce the same result in terms of the factor analytic and/or binary relationships.

The data is put into a computer database and the algorithm detects scores that are not in conformance with the expected scores based on the binary and factor analytic relationships. The user is alerted to the discrepancies that can then be investigated. The algorithm can be embodied in any suitable computer language and stored on any non-transitory computer readable medium, such as a CD.

We claim:

1. A method for detecting abnormalities in administering a clinical trial instrument, the method comprising:
determining numerical values for factors in at least one psychological instrument;
entering the numerical values for at least two items into a computer database;
comparing the numerical values for at least factors having a relationship with each other;
determining if the relationship is satisfied; and
generating an alert when the binary relationship is satisfied.

2. The method of claim 1, wherein the relationship between the numerical values for at least two items is a binary relationship.

3. The method of claim 1, wherein the relationship numerical values for at least two items is a factorial relationship.

4. The method of claim 3, wherein the factorial relationship is between factors of two psychological instruments.

5. The method of claim 1, wherein the at least one psychological instrument is MADRS.

6. A non-transitory computer readable medium containing computer instructions stored therein for causing a computer processor to perform a method, the method including:
determining numerical values for factors in at least one psychological instrument;
entering the numerical values for at least two items into a computer database;
comparing the numerical values for at least factors having a relationship with each other;
determining if the relationship is satisfied; and
generating an alert when the binary relationship is satisfied.

7. The non-transitory computer readable medium of claim 6, wherein the relationship between the numerical values for at least two items is a binary relationship.

8. The non-transitory computer readable medium of claim 6, wherein the relationship numerical values for at least two items is a factorial relationship.

9. The non-transitory computer readable medium of claim 8, wherein the factorial relationship is between factors of two psychological instruments.

10. The non-transitory computer readable medium of claim 6, wherein the at least one psychological instrument is MADRS.

11. A method for detecting abnormalities in administering a clinical trial, the method comprising:
administering questions to a patient to ascertain numerical values for at least two items for at least one psychological instrument;
entering the numerical values for at least two items into a computer database;
determining an expected correlation between the at least two items;
comparing the entered values of the at least two items to values based on the expected correlation; and
generating an alert when the difference between the actual values of the at least two items are different than the expected difference based on the correlation.

12. The method of claim 11, wherein the expected correlation is binary.

13. The method of claim 11, wherein the expected correlation is factorial.

14. A non-transitory computer readable medium containing computer instructions stored therein for causing a computer processor to perform a method, the method including:
administering questions to a patient to ascertain numerical values for at least two items for at least one psychological instrument;
entering the numerical values for at least two items into a computer database;
determining an expected correlation between the at least two items;
comparing the entered values of the at least two items to values based on the expected correlation; and
generating an alert when the difference between the actual values of the at least two items are different than the expected difference based on the correlation.

15. The method of claim 14, wherein the expected correlation is binary.

16. The method of claim 14, wherein the expected correlation is factorial.
